(19) United States
(12) Patent Application Publication
(10) Pub. No.: US 2010/0294421 A1
(43) Pub. Date: Nov. 25, 2010

(54) METHOD FOR MANUFACTURING REINFORCED RUBBER HOSE

(75) Inventors: Sohei Fujiki, Okayama (JP); Takashi Miyake, Okayama (JP); Hifumi Yasumatsu, Okayama (JP); Shigeto Ohga, Okayama (JP); Yasuaki Fujiwara, Okayama (JP); Toshihiro Baba, Okayama (JP); Haruka Yamakawa, Okayama (JP); Hiroshi Nobuhara, Okayama (JP)

Correspondence Address: BUCHANAN, INGERSOLL & ROONEY PC, POST OFFICE BOX 1404, ALEXANDRIA, VA, 22313-1404, US

(73) Assignee: Marugo Rubber Industries, Ltd., Kurashiki-shi (JP)

(21) Appl. No.: 12/744,417

(22) PCT Filed: Nov. 19, 2008
(86) PCT No.: PCT/JP2008/070978

§ 371 Date: May 24, 2010

(30) Foreign Application Priority Data
Nov. 22, 2007 (JP) 2007-302713

(51) Int. Cl. B29D 23/18

(52) U.S. Cl. 156/156

(57) ABSTRACT

An inner mold having, on the outer surface thereof, corrugations matching the shape of the bellows, and an outer mold having, on the inner surface thereof, corrugations matching the shape of the bellows, are used. An airbag that is previously and at least partially formed into a bellows shape is placed on an outer side of the inner mold so as to cover at least a corrugated part with the airbag. A cylindrical preform comprising unvulcanized rubber and a reinforcement material is placed on the outer side of the airbag. An outer mold is placed on the outer side of the preform. A pressurized fluid is supplied between the inner mold and the airbag so as to inflate the airbag. The preform is vulcanized under heating while being pressed against an inner surface of the outer mold, whereby a reinforced rubber hose is manufactured.

### TECHNICAL FIELD

The present invention relates to a method for manufacturing a reinforced rubber hose having bellows. In particular, the present invention relates to a method for manufacturing a reinforced rubber hose suitable for use in automobiles as an intercooler hose, a retarder hose, or a radiator hose.

### BACKGROUND ART

Recently, exhaust emissions regulations of diesel-powered vehicles have become more and more stringent each year. New short-term exhaust emissions regulations became effective in 2003 to 2004, new long-term exhaust emissions regulations became effective in 2005, and in addition, the enforcement of post new long-term exhaust emissions regulations is scheduled in 2009 to 2010. From viewpoint of passing such strict exhaust emissions regulations, improvement in the post-processing technology to process the combustion gas exhausted from the engine with catalysts and the like will not be effective enough. Improvement of the combustion condition in the engine itself will also be necessary. For this reason, further raising the temperature and the pressure of the air supply line to the engine is being demanded.

In the automobiles equipped with a turbocharger, rubber hoses are used for the connection between the turbocharger and the intercooler, and between the intercooler and the engine. This hose is called an intercooler hose. Because of severe vibrations generated in each component of vehicles such as large size trucks, bellows are formed on the intercooler hose to absorb the vibration. Machine molding of rubber hoses having bellows to be used for this purpose has been difficult because of the large bore, and the great depth of the bellows (the difference between the radius at the convex part and that at the concave part). For such a case, therefore, manual work was necessary. As for the air supply line to the engine, as the demand for applicability to higher temperatures and higher pressures increases, the demand on the shape of the bellows will be more stringent, making the mechanization even more difficult.

Moreover, in recent years, the demand for various hoses used for automobiles is becoming more stringent because of tightening of the environmental regulations, a demand for energy conservation, a demand for decreased body weight, and a demand for enhanced safety of automobiles, in particular, for large-size automobiles. For example, there is an increased demand for retarder hoses and radiator hoses, resistant to high temperatures and high pressures, lightweight and having excellent mechanical characteristics. For these hoses as well, formation of bellows to adequately absorb the vibration is being demanded.

A typical procedure for manufacturing rubber hoses having this type of bellows is as follows: (a) A rubber sheet is prepared by laminating silicone rubber to one or both sides of a cloth made by weaving or knitting Aramid fiber or the like; (b) The rubber sheet is wrapped around a mandrel (inner mold) having a predetermined bellows-shaped surface to be made into a cylindrical preform. At this time, a fluorine rubber sheet may be additionally wrapped as the inner layer; (c) A heat-shrinkable tape is manually wrapped around the outside of the preform, so that a part corresponding to a concave part of the bellows shape matches the shape of the mandrel surface; and (d) The bellows shape is formed by heating the preform in a boiler to shrink the tape and vulcanize the silicon rubber. The hardest step is (c) as it requires prolonged manual work and a considerable level of skill to perform this type of manual works. It also involves a tape removal step. This step is not cost-effective as the tape is not reusable.

As a method for manufacturing the rubber hose having the bellows, Patent Document 1 describes a method, comprising: forming a large number of through-holes for communicating a hollow part and an outer part, on a bellows-shaped mandrel having the hollow part inside; fitting a right cylindrical unvulcanized rubber hose on an outer periphery of the mandrel; sealing both ends of the unvulcanized rubber hose and the outer periphery of the mandrel; and reducing a pressure inside the hollow part of the mandrel, under a vulcanization condition, below an atmospheric pressure of outside, whereby the rubber hose is formed into a bellows shape fitting along the shape of the mandrel.

Further, Patent Document 2 describes a method for manufacturing a curved hose having bellows, comprising: inserting a predetermined bent-shaped jig into an unvulcanized rubber hose, except a part forming the bellows; bending the unvulcanized rubber hose; placing the rubber hose in a mold having a bellows-shaped mold surface on an inner periphery surface; pressing the unvulcanized rubber hose against the mold surface by introduction of pressurized air into a center hole of the unvulcanized rubber hose thereby to shape it into a bellows shape; and vulcanizing the resultant product under this condition.

However, the manufacturing methods described in Patent Documents 1 and 2 both concern the molding by using the unvulcanized rubber hoses not having a reinforcement material. There is no description regarding a molding method by using an unvulcanized rubber hose having the reinforcement material. It is difficult to form the bellows shape on the unvulcanized rubber hoses having a reinforcement material by using the manufacturing methods described in either reference. As the unvulcanized rubber hose with a reinforcement material has a high rigidity, and thus, it is not easily expanded. As a result, the entire hose needs to shrink in the lengthwise direction in order to form a deep bellows shape. However, when the manufacturing methods described in the above-described Patent Documents are used, the movement of the hose in the lengthwise direction is restricted by the constraint of the contacting mold and therefore the formation of deep bellows shape is difficult. More specifically, when the manufacturing method described in Patent Document 1 is used, the unvulcanized rubber hose is first pressed against the convex part of the mandrel at the time of reducing a pressure inside the hollow part of the mandrel. This makes deformation to fit along the concave part difficult. Also, when the manufacturing method described in Patent Document 2 is used, the unvulcanized rubber hose is first pressed against the convex part at the time of inflating the rubber hose by the introduction of the pressurized air, and therefore deformation to fit along the concave part is also difficult.

Patent Document 3 describes a method for manufacturing a rubber structure, comprising: laminating rubber and cords on an outer side of a cylindrical airbag to mold a cylindrical unvulcanized rubber formed body; inserting the formed body, which is still held by the airbag, into a product mold; inflating the airbag by pressurization to expand a diameter of the formed body outside thereof while reducing in length the airbag and the formed body; and vulcanizing the formed body. However, no mention has been provided as to the manufacturing the reinforced rubber hose having a bellows shape in Patent Document 3.

### Patent Document 1: JP 59-199235 A

### Patent Document 2: JP 5-301298 A

### Patent Document 3: JP 2006-264204 A

### SUMMARY OF INVENTION

### Technical Problem

The present invention has been achieved to solve the above-described problems. An object of the present invention is to provide a method for manufacturing a bellows-shaped reinforced rubber hoses having a good size precision, capable of reducing a manufacturing cost and increasing the productivity by eliminating a manual work that requires a considerable level of skill.

### Solution to Problem

The above-described problems can be resolved by a method for manufacturing a reinforced rubber hose having bellows, by using an inner mold having, on the outer surface thereof, corrugations matching the shape of the bellows, and an outer mold having, on the inner surface thereof, corrugations matching the shape of the bellows, the method comprising following steps of: placing an airbag that is previously formed into a bellows shape at least partially, on the out side of the inner mold, so as to cover at least a corrugated part with the airbag; placing a cylindrical preform comprising unvulcanized rubber and a reinforcement material on the outside of the airbag; placing the outer mold on the outside of the preform; supplying a pressurized fluid between the inner mold and the airbag so as to inflate the airbag; and vulcanizing the preform under heating while being pressed against an inner surface of the outer mold.

According to this manufacturing method, because the airbag that is previously formed into a bellows shape is used, the convex part of the airbag first contacts the preform at the time of inflating the airbag by supplying a pressurized fluid and the concave part of the airbag finally contacts the preform. Therefore, the preform is pressed against the outer mold in a shape matching the bellows shape of the airbag to facilitate the molding of a bellows shape having a good size precision. Moreover, the preform is pressed against the outer mold after the mold is closed, and thus, there is only a small amount of inroad on a dividing surface of the mold, and there is no possibility that a reinforcement layer is clamped in the mold. Further, because the airbag is directly pressed against the preform inner surface, the inner surface of the molded product is smooth.

In the above-described manufacturing method, it is preferable that a gas between the airbag and the preform be depressurized and evacuated before inflating the airbag so as to press the preform against the airbag. It is also preferable that a clearance between the inner mold and the outer mold across the corrugated part be greater than a total of the thickness of the hose after vulcanization and the thickness of the airbag. It is further preferable that an uncorrugated cylindrical part be provided at least at one end of the inner mold, the cylindrical part be not covered with the airbag at least partially, and the preform directly contact the inner mold. In the above-described manufacturing method, it is preferable that the airbag be made of vulcanized rubber formed into a bellows shape. It is preferable that the preform be formed into a tubular shape by rolling a reinforced rubber sheet made of unvalcanized rubber and a reinforcement material. It is also preferable that the preform be so formed that unvulcanized rubber is kneaded, extruded in a tubular shape, and then combined with a reinforcement material.

In a preferred embodiment of the present invention, the reinforced rubber hose is an intercooler hose, a retarder hose, or a radiator hose.

### ADVANTAGEOUS EFFECTS OF INVENTION

According to a method for manufacturing a reinforced rubber hose of the present invention, reduction in a manufacturing cost and an increase in productivity can be realized by eliminating a manual work that requires a considerable level of skill. Moreover, a bellows-shaped reinforced rubber hose having a good size precision can be produced.

### BRIEF DESCRIPTION OF DRAWINGS

FIG. 1 is a cross-sectional view showing one example of a reinforced rubber hose 10 having bellows manufactured by using a manufacturing method of the present invention.

FIG. 2 is a cross-sectional view of one example of an inner mold 40.

FIG. 3 is a cross-sectional view of a state where the inner mold 40 is covered with an airbag 30.

FIG. 4 is a cross-sectional view showing a state where the preform 20 is placed on the outside of the inner mold 40.

FIG. 5 is a cross-sectional view showing a state where a bellows shape is prepared by de-pressurization formation of the preform 20.

FIG. 6 is a cross-sectional view showing a state where the preform 20 is covered with an outer mold 50.

FIG. 7 is a partially expanded cross-sectional view of FIG. 6.

FIG. 8 is a cross-sectional view of a state where the airbag 30 is inflated by supplying a pressurized fluid.

### REFERENCE SIGN LIST

10 reinforced rubber hose
11, 31, 41, 52 convex part
12, 32, 42, 51 concave part
13 bellows
14 straight tube part
20 preform
30 airbag
33, 34 cylindrical cover
40 inner mold
43 corrugated part
44 cylindrical part
45 depressurizing line
46 gas outlet
47 pressurized-gas supply port
48 hollow part
49 through-hole
50 outer mold
53 clearance

### DESCRIPTION OF EMBODIMENTS

### Configuration of Reinforced Rubber Hose 10 Having Bellows

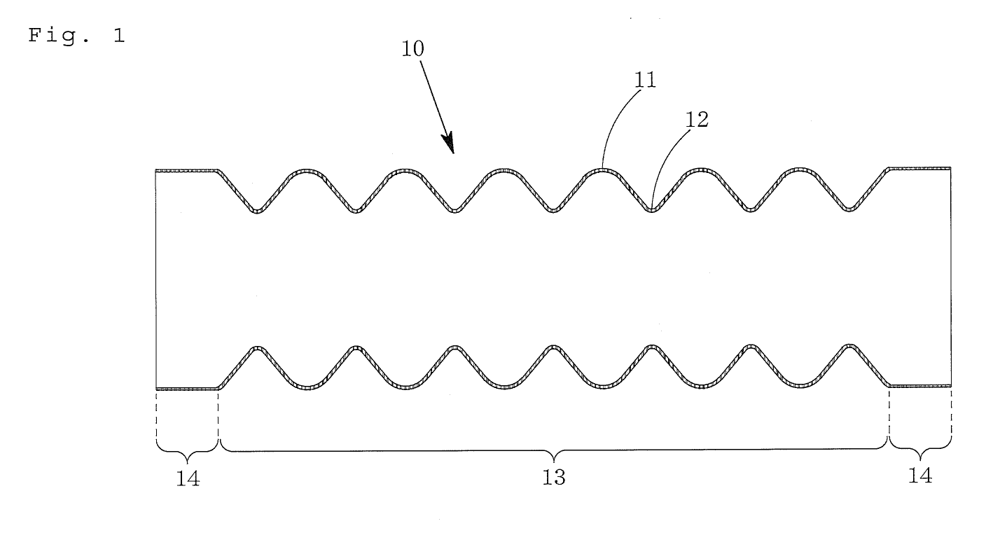

Hereinafter, embodiments of the present invention will be explained with reference to drawings. FIG. 1 is a cross-sectional view showing one example of a reinforced rubber hose 10 having bellows manufactured by using a manufacturing method of the present invention. This reinforced rubber hose 10 comprises: a bellows 13 having convex parts 11 and concave parts 12 alternately formed thereon; and straight tube parts 14 located at both sides thereof. In the present invention, the reinforced rubber hose 10 may be entirely straight or bent. Even if the entire reinforced rubber hose 10 is bent, the bellows 13 is usually molded at a straight part. The number and the depth of each convex part 11 and each concave part 12 in the bellows 13 may be appropriately determined to fit the purpose of the use. In an example in FIG. 1, the number of the convex parts 11 of the bellows is six. However, the number is not limited, and is usually between 1 and 30. A difference in level between the convex part 11 and the concave part 12, that is, the depth of the bellows may vary. It is usually about 2 to 30 mm. As the formation of deep bellows shape is feasible according to the manufacturing method of the present invention, it is profitable to adopt the method of the present invention at the time of manufacturing the reinforced rubber hose 10 having deep bellows. Therefore, a preferred depth of the bellows is 3 mm or greater, and more preferably 4 mm or greater. The thickness of the reinforced rubber hose 10 is usually about 1 to 10 mm at a part where the bellows is not formed.

### [Preparation of Reinforced Rubber Sheet]

A reinforcement material used for reinforcement of rubber hose in the present invention is not limited to a specific material, and any fibers or films can be used. In particular, fibers are preferable for reinforcement, and cloths are more preferable. In this case, fibers are woven or knit to produce reinforcement cloths. Although a type of fibers for this is not limited, highly heat-resistant and high-strength fibers such as aromatic polyamides, carbon fibers, and glass fibers are preferably used. Unvulcanized reinforced rubber sheets are prepared by, for example, applying rubber on the reinforcement cloths. To apply unvulcanized rubber on the reinforcement cloths, conventional methods such as a method using a calendar roller are used. Rubbers used are not limited to any specific materials. Heat-resistant and chemical-resistant rubbers are preferred. Preferably used rubbers include silicone rubbers, fluorinated rubbers, fluorosilicone rubbers, and acrylic rubbers.

### [Preparation of Preform 20]

The preform 20 is a tubular molded product made of unvulcanized rubber and a reinforcement material. Preferably, the tubular preform 20 is formed by rolling the reinforced rubber sheet prepared as described above. The reinforced rubber sheet may be directly wrapped around an inner mold 40 having the airbag 30 placed thereon to prepare the preform 20. However, preferably, the preform 20 in a straight tube shape is prepared in advance by wrapping the reinforced rubber sheet around a straight tube mandrel. The number of wrapping is adjusted depending on the intended purpose and usually is between 2 and 10 layers. One type of reinforced rubber sheet may be used for the entire configuration or a plurality of different types of reinforced rubber sheets may be wrapped around one by one. For example, a preferred configuration of the preform 20 is achieved as follows: a reinforced rubber sheet made of a highly chemical-resistant rubber material such as fluorinated rubber and fluorosilicone rubber is wrapped as the inner-most layer, and a reinforced rubber sheet made of silicone rubber is wrapped around the outer periphery of the inner-most layer. In this case, it is preferable that the rubber sheet of the inner-most layer have one to two layers, and the rubber sheet of the outer layer have two to five layers.

As another method for preparing the preform 20, a method in which kneaded unvulcanized rubber is first extruded in a cylindrical shape and then combined with a reinforcement material, can be listed. In this case, unvulcanized rubber is extruded from a kneading equipment such as an extruder into a tubular shape, and then combined with a reinforcement material. A combining method is not specifically limited. The outer surface of the tubular unvulcanized rubber can be covered with a reinforcement cloth or a reinforcement thread. The surface may be further covered with unvulcanized rubber.

### [Attaching of the Airbag 30]

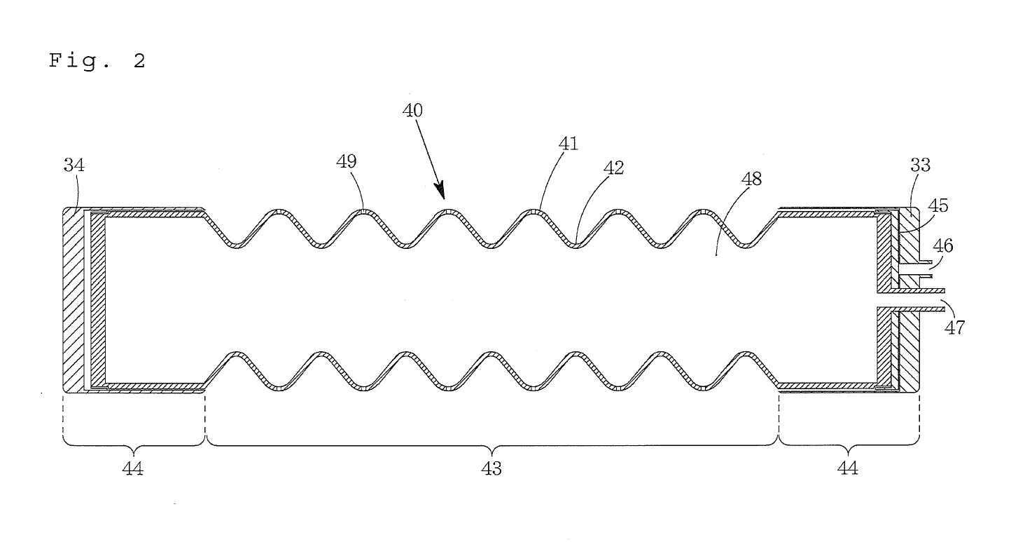

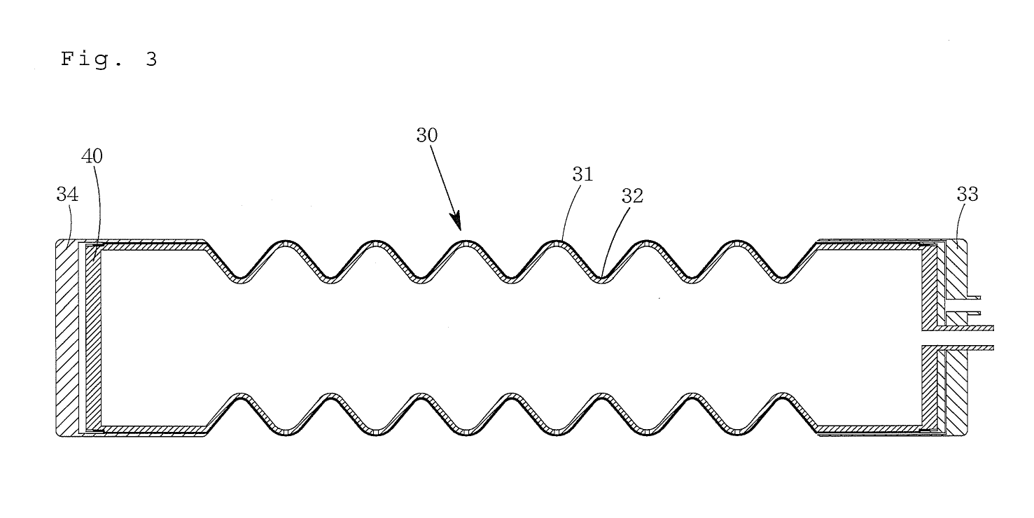

In the manufacturing method of the present invention, the airbag 30 is attached on the outside of the inner mold 40. A cross-sectional view of one example of the inner mold 40 is shown in FIG. 2. A cross-sectional view of a state where the inner mold 40 is covered with the airbag 30 is shown in FIG. 3. The airbag 30 is placed on the outside of the inner mold 40 so as to be inflated with a supply of pressurized fluid therein. Therefore, the airbag 30 is made of a sheet which is elastic and impermeable to gases. The material for the airbag 30 is preferably a heat-resistant rubber, in particular, vulcanized rubber, because the airbag 30 will be placed under a high temperature condition at the time of following vulcanization. Examples thereof include silicone rubber and acrylic rubber. In consideration of the durability, as it is used repeatedly, it is preferably made of vulcanized rubber and a reinforcement material, but a material consisting only of rubber may be used as well. A molding method is not particularly limited as long as it is capable of previously forming a bellows shape. The airbag 30 can also be prepared by first fitting a rubber sheet along the inner mold 40 having corrugations matching the shape of the bellows on the outer surface, followed by vulcanization molding.

The airbag 30 used in the present invention is characterized by being previously formed in a bellows shape at least partially. Therefore, the airbag 30 is deformed to fit the bellows shape while it is pressed against the surface of the inner mold 40, and the airbag 30 still keeps its bellows shape even after the pressing force is deactivated. When the already shaped airbag is used in this way, the convex part 31 of the airbag 30 first contacts the preform 20 and the concave part 32 of the airbag 30 finally contacts the preform 20, at the time the airbag 30 is inflated by supplying the pressurized fluid. Therefore, the preform 20 is pressed against the outer mold 50 in a shape matching the bellows shape of the airbag 30 to facilitate the molding of a bellows shape having a good size precision. The bellows shape of the airbag 30 matches a corrugations pattern formed on the outer surface of the inner mold 40.

The airbag 30 is placed on the outside of the inner mold 40, and covers a corrugated part 43 formed on the outer surface of the inner mold 40. The both ends of airbag 30 can be made airtight not to release the gas inside as a result of the both ends being clamped by the inner mold 40 and the outer mold 50 when the both molds 40 and 50 are combined. Although the airbag 30 can cover the entire part (including an end) of the inner mold 40, it is preferred not to cover the end of the inner mold 40 with the airbag 30. That is, it is preferable that at least one end of the inner mold 40 have an uncorrugated cylindrical part 44, and at least one portion of the cylindrical part 44 be not covered with the airbag 30, so that the preform 20 can directly contact the inner mold 40. In an example of FIG. 3, the inner mold 40 can be divided into three parts, i.e., a main body of the inner mold 40, and tubular covers 33 and 34 covering both ends. The both ends of the airbag 30 are clamped between the cylindrical covers 33, 34 and the main body of the inner mold 40. In this case, the ends of the cylindrical part 44 not covered with the airbag 30 correspond to parts, that are fit into a connected pipe, of the reinforced rubber hose 10. In this manner, a size precision of the inner diameter at the end of the reinforced rubber hose 10 thus obtained is increased. This is because the inner diameter is not affected by the size of the airbag 30 but determined solely by the size of the inner mold 40. Because the end of the reinforced rubber hose 10 is connected with a pipe, etc., the size precision of the inner diameter is important.

### [Attaching of Preform 20]

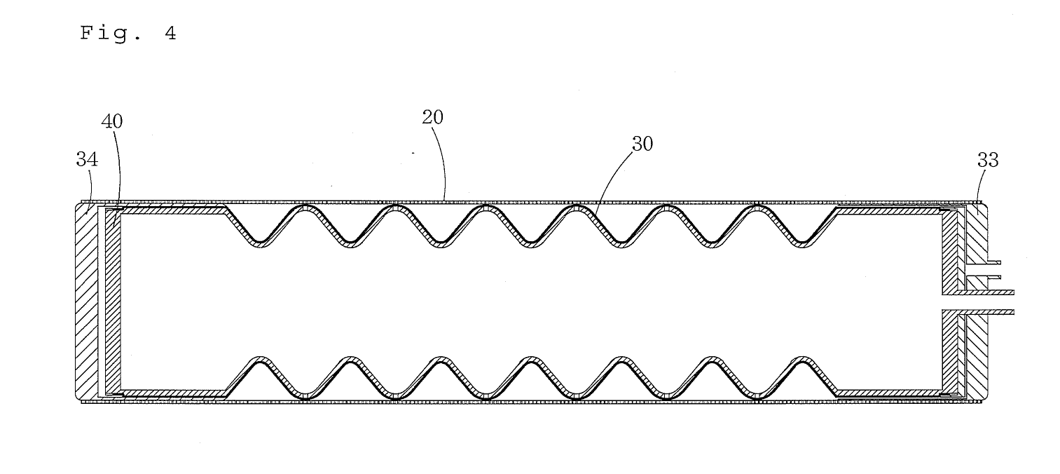

The preform 20 is placed on the outside of the inner mold 40 covered with the airbag 30, as described above. FIG. 4 is a cross-sectional view showing a state where the preform 20 is placed on the outside of the inner mold 40. At this time, instead of inserting the inner mold 40 into the tubular preform 20 prepared in advance, the reinforced rubber sheet may be directly wrapped around the inner mold 40 to prepare the preform 20. The inner diameter of the preform 20 must be roughly the same as the outer diameter of the convex part of the corrugations of the inner mold 40. On the outer surface of the inner mold 40, the corrugations that match the shape of the bellows to be formed on the reinforced rubber hose 10 are formed. The corrugated convex part 41 and concave part 42 are formed at locations corresponding to the convex part 11 and the concave part 12 of the bellows on the reinforced rubber hose 10, respectively.

### [De-Pressurization Formation]

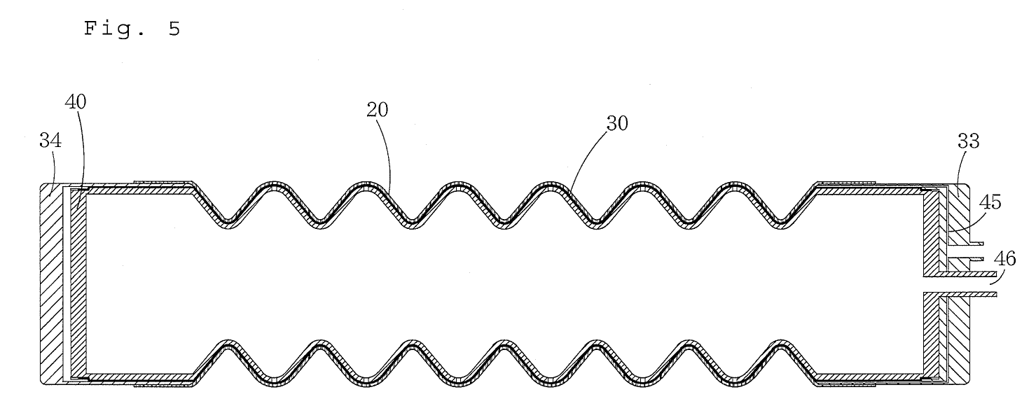

FIG. 5 is a cross-sectional view showing a state where the bellows shape is prepared by de-pressurization formation of the preform 20. After attaching the preform 20 on the outside of the inner mold 40, the gas between the airbag 30 and the preform 20 is depressurized and evacuated to press the preform 20 against the airbag 30. A depressurizing line 45 is provided between the airbag 30 and the preform 20. The gas in the area between the airbag 30 and the preform 20 is exhausted from a gas outlet 46 through the depressurizing line 45. The gas outlet 46 is connected to a vacuum pump (not shown). As the gas in the area between the airbag 30 and the preform 20 is being exhausted, the preform 20 begins to match the surface shape of the inner mold 40 while shrinking along the axial direction. Thus, the pressure is reduced in advance, and then, the preform 20 is molded. The result is that the bellows shape is formed absorbing the shrinkage, which provides room for further deformation at the time of a subsequent pressurization formation. Accordingly, this method is suitable for the formation of a deep bellows shape. For applications where requirements of conditions including temperature, pressure, and vibration are stringent, hoses with a deep bellows shape or hoses with a plurality of reinforcement layers are often demanded. A reinforcement layer part of such a hose is not easily expandable, and thus, the preform 20 may not be inflated to a desired bellows shape or may even break when a pressure is applied through the airbag 30. In such a case, this de-pressurization formation process will be useful. This de-pressurization formation process, however, is not the requisite process in the manufacturing method of the present invention. A pressurization formation process explained below may be executed without performing this process. Depending on a specification of the reinforced rubber hose 10, there will be cases where adequate shape can be formed even when the de-pressurization formation process is omitted.

### [Pressurization Formation and Vulcanization]

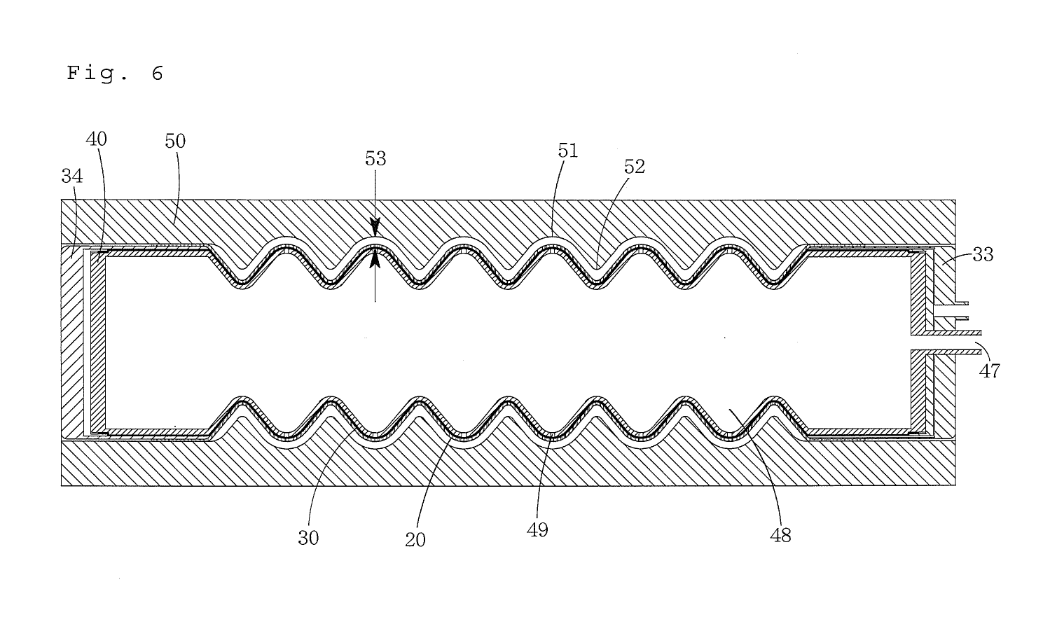

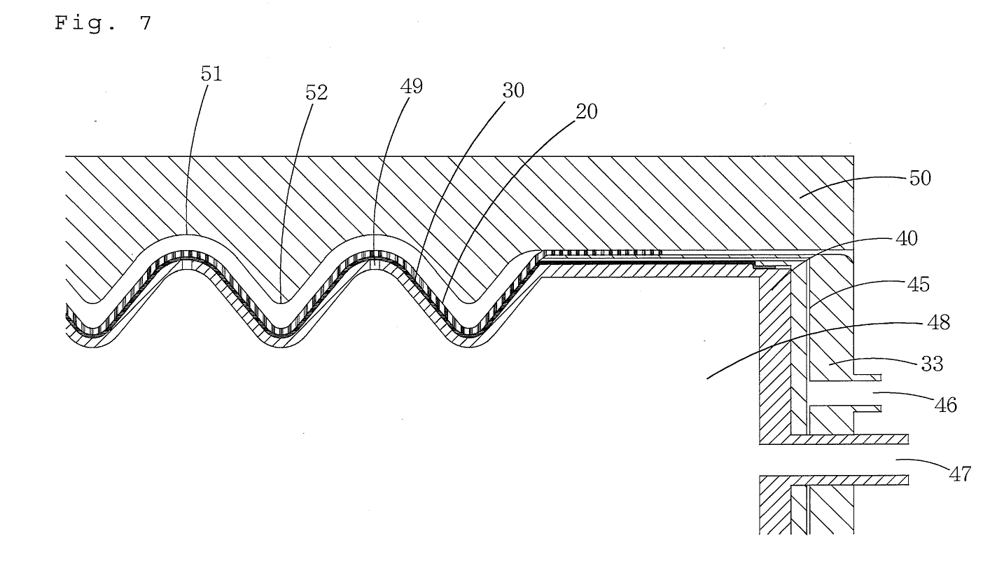

The outer mold 50 is placed to cover the preform 20 set on the outside of the inner mold 40 which is covered with the airbag 30. FIG. 6 is a cross-sectional view showing a state where the preform 20 is covered with the outer mold 50. FIG. 7 is a partially expanded cross-sectional view. On the inner surface of the outer mold 50, corrugations matching the bellows shape to be formed on the reinforced rubber hose 10 are formed. The outer mold 50 usually can be separated into top and the bottom molds, which are combined to cover the inner mold 40. At this time, the de-pressurization formation process may be omitted. However, in order to form the deep bellows shape with a good size precision, it is preferable that the de-pressurization formation process preferably be carried out to form the bellows shape on the preform 20 in advance, and the bellows shape be covered with the outer mold 50.

A clearance 53 between the inner mold 40 and the outer mold 50 across the corrugated part 43 is adjusted to be greater than a total of the thickness of the hose after vulcanization and the thickness of the airbag 30. In the manufacturing method of the present invention, the preform 20 is not compressed between the inner mold 40 and the outer mold 50 for shaping; but the airbag 30 is inflated so as to press the preform 20 against the inner surface of the outer mold 50 for molding. Therefore, setting of this clearance 53 is important. The clearance 53 is preferably greater than 1.2 times, more preferably greater than 1.4 times a total of the thickness of the hose after vulcanization and the thickness of the airbag 30. On the other hand, if the clearance 53 is too great, a deformation during the pressurization formation process will be excessively large, which may lower the size precision. Therefore, the clearance 53 is preferably equal to or less than five times, more preferably equal to or less than three times a total of the thickness of the hose after vulcanization and the thickness of the airbag 30. Here, the thickness of hose after vulcanization means the thickness in a part where no bellows are formed. In a part where the bellows are formed, the thickness is often slightly smaller.

After covering the inner mold 40 with the outer mold 50, the airbag 30 is inflated by supplying a pressurized fluid into a space between the inner mold 40 and the airbag 30. The preform 20 is vulcanized under heating while it is pressed against the inner surface of the outer mold 50. Although a pressurized liquid may be used as the pressurized fluid, a pressurized gas is usually used. The pressurized gas is supplied from the pressurized-gas supply port 47 into a hollow part 48 located inside the inner mold 40. The pressurized gas supplied to the hollow part 48 passes through a plurality of through-holes 49 formed on the outer surface of the inner mold 40 and inflates the airbag 30. At this time, locations of the through-holes 49 are not particularly limited; however, the through-holes 49 preferably are formed at the convex parts 41 of the corrugations on the outer surface of the inner mold 40. That is, it is preferable that the inner mold 40 be hollow; the convex parts 41 of the corrugations on its outer surface have the through-holes 49; and the airbag 30 be inflated by the supply of the pressurized gas through the through-holes 49. In this manner, the convex parts 31 of the airbag 30 can effectively press the preform 20. This facilitates the formation of a deep bellows shape. The number of the through-holes 49 formed on each convex part 41 is one or more, preferably two or more, and more preferably three or more. A method for supplying a pressurized gas is not particularly limited. Instead of forming the through-holes 49, grooves for supplying the pressurized gas may be formed on the surface of the inner mold 40 contacting the airbag 30. The pressure of the pressurized gas is not particularly limited as long as it is equal to or more than an atmospheric pressure (0.1 MPa). However, in order to form the deep bellows shape with a good size precision, a pressure equal to or more than 0.2 MPa is preferable.

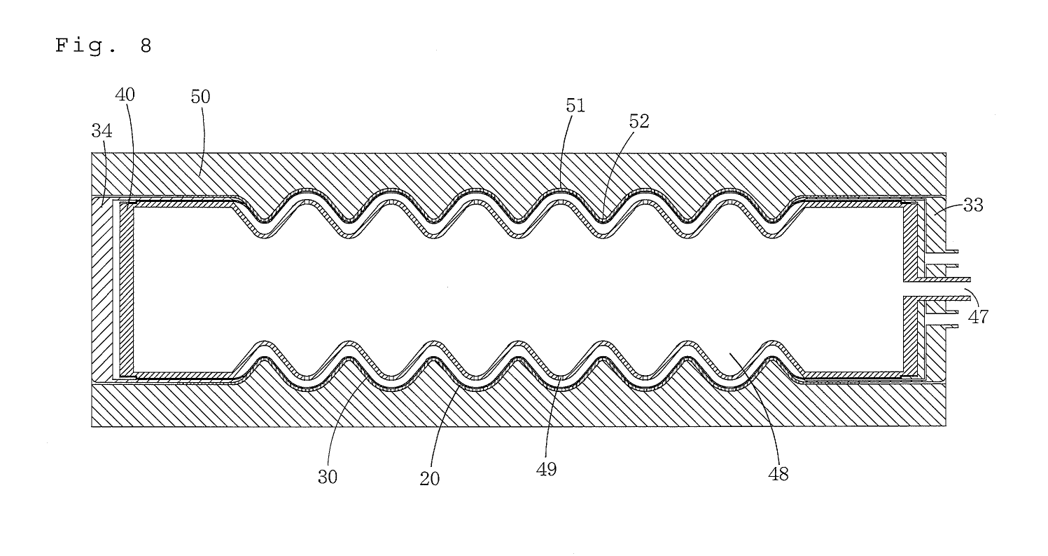

The bellows shape is formed by inflating the airbag 30 followed by heating and vulcanizing the preform 20 while it is tightly pressed against the inner surface of the outer mold 50. FIG. 8 is a cross-sectional view of a state where the airbag 30 is inflated by supplying a pressurized fluid. Because the preform 20 is vulcanized while it is directly pressed against the inner surface of the outer mold 50, the reinforced rubber hose 10 having a shape exactly matching that of the outer mold 50 and having a smooth outer surface is manufactured. In this case, the vulcanization method is not particularly limited. It may be performed in a vulcanizer, or may be performed with an electric heating press. Vulcanization conditions are adjusted depending on the type of rubbers or vulcanization agents to be used. After the vulcanization, the airbag 30 is shrunk by stopping the pressurization and the outer mold 50 is removed. Then, air is blown into the space between the inner mold 40 and the reinforced rubber hose 10 to expand the reinforced rubber hose 10 to remove it from the inner mold 40. The airbag 30 is reusable.

The reinforced rubber hose 10 of the present invention thus obtained has a bellows shape with a good size precision while it contains a reinforcement material. Also, the formation of deep bellows shape is easy. It can be used for various purposes. For example, the reinforced rubber hose 10 is suitably used as a hose for various types of vehicles, mainly automobiles. Specifically, the reinforced rubber hose 10 is suitably used as an intercooler hose, a retarder hose, or a radiator hose. In this case, the intercooler hose is a hose used for the mutual connection between a turbocharger and an intercooler, or between the intercooler and an engine. The retarder hose is a hose to direct a coolant from a radiator, etc., to the retarder in order to cool oil that is used as a fluid for resistance in a hydraulic retarder that is a type of auxiliary brakes. The radiator hose is a hose connecting the radiator and the engine to transfer the coolant. Among these usages, the reinforced rubber hose 10 is suitably used as an intercooler hose for which heat resistivity and oil-mist resistivity are demanded. The intercooler hose of the present invention can be adopted for various automobiles. Particularly, it is suitably used for large-size automobiles such as trucks and buses.

### EXAMPLES

The present invention is explained in more detail with reference to examples, below.

### Example 1

The inner mold 40 used in this example has, on its outer surface, five convex parts 41 at a height of 3 mm, formed at a pitch of 25 mm. The inner mold 40 has, at the both ends, 60-mm cylindrical parts 44 having no convex or concave parts formed thereon. The inside of the inner mold 40 is hollow, and four through holes 49, 2 mm in diameter, are formed on each convex part 41.

A method for preparing the airbag 30 is as follows. A 1-mm thick unvulcanized silicone rubber sheet containing a reinforcement cloth layer was wrapped around once the inner mold 40 having, on the outer surface, the corrugations matching the bellows shape. The whole body was covered with an outer mold having top and the bottom molds. The outer mold used here had an inner surface shape having a 1-mm clearance from the inner mold 40. By subsequent vulcanization, the inner mold 40 to which the airbag 30 shaped in advance in a bellows shape is attached was obtained. The airbag 30 covered the entire corrugated part 43 of the inner mold 40, except the fitting parts at both ends of the inner mold 40 used for joining with pipes.

A method for preparing the preform 20 is as follows. First, a 1.25-mm thick reinforced rubber sheet was prepared by pasting unvulcanized silicone rubber on both surfaces of a woven Aramid cloth used as a reinforcement cloth. This rubber sheet was then wrapped twice around a straight tube mandrel having an outer diameter of 76 mm to obtain the cylindrical preform 20 having a total thickness of 2.5 mm.

The preform 20 thus obtained was removed from the straight tube mandrel, and the inner mold 40 having the airbag 30 attached thereon was inserted in the perform 20. The inner mold 40 was then covered with the outer mold 50 consisting of two separate pieces. The outer mold 50 has, on its inner surface, five 3-mm deep concave parts 51 arranged at a pitch of 25 mm to face the convex parts 41 of the inner mold 40. The clearance 53 between the inner mold 40 and the outer mold 50 was 6.5 mm, which was 1.86 times a total of the thickness of the hose of 2.5 mm after vulcanization and the thickness of the airbag 30 of 1 mm. Subsequently, pressurized air at 0.5 MPa was supplied into the hollow part 48 inside the inner mold 40. Vulcanization was performed in a vulcanizer under continued pressurization by heating for 30 minutes at 160° C. After the completion of vulcanization, pressurization was stopped, the airbag 30 was deflated, and the outer mold 50 was removed. The reinforced rubber hose 10 was then removed from the inner mold 40 by expanding the reinforced rubber hose 10 by blowing the air into the space between the inner mold 40 and the reinforced rubber hose 10.

The reinforced rubber hose 10 thus obtained had a total thickness of 2.5 mm at the straight tube part 14, the outer diameter of 76 mm at the convex part 11, and the outer diameter of 70 mm at the concave part 12. At any part, a height difference between the convex part 11 and the concave part 12 (the depth of the bellows) was 3 mm, indicating the close replication of the mold shape. The outer surface of the product was smooth. The results are summarized in Table 1.

### Comparative Example 1

This is an example in which a different airbag 30 from that which was used for the example 1 is used. A method for preparing the airbag 30 is as follows. A 1-mm thick unvulcanized silicone rubber sheet including a reinforcement cloth layer was wrapped once around a straight tube mandrel having an outer diameter of 60 mm and was vulcanized. The straight tube mandrel was covered with the airbag 30. The airbag 30 did not cover the fitting parts at both ends of the straight tube mandrel used for joining with pipes. In the straight tube mandrel, the through-holes 49 were arranged at the same locations as those of the inner mold 40 used in the example 1.

As described above, the reinforced rubber hose 10 having bellows was obtained in the same manner as for the example 1 except that in this case, the straight tube mandrel to which the airbag 30 was attached was used. The obtained reinforced rubber hose 10 had a total thickness of 2.5 mm at the straight tube part 14, an outer diameter of 73 mm at the convex part 11, and an outer diameter of 70 mm at the concave part 12. A height difference between the convex part 11 and the concave part 12 (the depth of the bellows) was about 1.5 mm, and a targeted bellows depth could not be obtained. In addition, the outer surface of the product around the convex part 11 of the bellows was not smooth. The results are summarized in Table 1.

TABLE 1

| | | Comparative |
|---|---|---|
| | Example 1 | Example 1 |
| Shape of Airbag | Bellows | Straight tube |
| De-pressurization | No | No |
| formation process | | |
| Outer diameter of | 76 | 73 |
| product at convex | | |
| part (mm) | | |
| Outer diameter of | 70 | 70 |
| product at concave | | |
| part (mm) | | |
| Bellows depth (mm) | 3 | 1.5 |
| Product outer | smooth | Not smooth at the |
| surface | | convex part |

As seen from the comparison of the results for the embodiment 1 and the comparative example 1, the deeper bellows shape with a better size precision was obtained by using the airbag 30 having the bellows shape formed in advance, as compared with case of using the airbag 30 in a straight tube shape. Also, the product surface was smooth and appealing. The results in the example 1 probably arise from the fact that the airbag 30 having the bellows shape formed in advance was inflated and the preform 20 was pressed evenly against the corrugated part of the outer mold 50. On the other hand, the results in the comparative example 1 probably arise from the fact that when the airbag 30 was inflated, the perform 20 could not contact the concave part 51 of the outer mold 50 because the preform 20 first contacted the convex part 52 (i.e., the concave part 12 of the product) of the outer mold 50 and therefore the deformation matching to the concave part 51 (the convex part 11 of the product) of the outer mold 50 was restricted. That is, satisfactory bellows shape could not be obtained by the use of the airbag 30 in a straight tube shape.

### Example 2

The inner mold 40 used in this example has five 6.5-mm deep convex parts 41 at a pitch of 26 mm formed on the outer surface thereof. The inner mold 40 has, at both ends, 70-mm long cylindrical parts 44 having no convex or concave parts thereon. The outer diameter of the cylindrical part 44 is 101 mm. The inside of the cylindrical part 44 is hollow and the four through holes 49, 2 mm in diameter, are formed on each convex part 41.

A method for preparing the airbag 30 is as follows. A 1-mm thick unvulcanized silicone rubber sheet containing a reinforcement cloth layer was wrapped once around the inner mold 40 having, on the outer surface, the corrugations matching the bellows shape. Then the silicone rubber sheet was covered with the outer mold having top and bottom molds. The inner surface of the outer mold used in this case is shaped to have a clearance of 1 mm from the inner mold 40. By subsequent vulcanization, the inner mold 40 to which the airbag 30 having a bellows shape formed in advance was attached was obtained. The airbag 30 covered the entire corrugated part 43 of the inner mold 40, except the fitting parts at both ends of the inner mold 40 used for joining with pipes.

A method for preparing the preform 20 is as follows. First, a 1.2-mm thick reinforced rubber sheet was prepared by pasting unvulcanized silicone rubber on both surfaces of a woven Aramid cloth used as a reinforcement cloth. This rubber sheet was then wrapped three times around a straight tube mandrel having an outer diameter of 99 mm to obtain the tubular preform 20 having a total thickness of 3.6 mm.

The preform 20 thus obtained was removed from the straight tube mandrel and the inner mold 40 having the airbag 30 attached thereon was inserted. The gas between the airbag 30 and the preform 20 was depressurized and evacuated to match the preform 20 with the surface shape of the inner mold 40. The inner mold 40 was then covered with the outer mold 50 consisting of two separate pieces. The outer mold 50 has, on its inner surface, five 6.5-mm deep concave parts 51 arranged at a pitch of 26 mm facing the convex parts 41 of the inner mold 40. The clearance 53 between the inner mold 40 and the outer mold 50 was 7.6 mm, which was 1.65 times a total of the hose thickness (3.6 mm) after vulcanization and the thickness (1 mm) of the airbag 30. Subsequently, pressurized air at 0.5 MPa was supplied into the hollow part 48 inside the inner mold 40. Vulcanization was performed in a vulcanizer under continued pressurization by heating for 30 minutes at 160° C. After that, pressurization was stopped, the airbag 30 was deflated, and the outer mold 50 was removed. The reinforced rubber hose 10 was then removed from the inner mold 40 by expanding the reinforced rubber hose 10 by blowing the air into the space between the inner mold 40 and the reinforced rubber hose 10.

The reinforced rubber hose 10 thus obtained had a total thickness of 3.6 mm at the straight tube part 14, an outer diameter of 114 mm at the convex part 11, and an outer diameter of 101 mm at the concave part 12. At any part, a height difference between the convex part 11 and the concave part 12 (the depth of the bellows) was 6.5 mm, indicating the exact replication of the mold shape. Inner diameters at the both ends of three samples prepared by the identical method were within the range of 100.7 to 101.2 mm. The outer surface of the product was smooth. The results are summarized in Table 2.

### Example 3

A reinforced rubber hose 10 having a bellows was obtained in the same manner as for the example 2 except that the de-pressurization formation process was not performed. That is, the example 3 was carried out similarly to the example 2 except that in this case the inner mold 40 having the airbag 30 attached thereon was inserted into the preform 20 and the inner mold 40 was immediately covered with the outer mold 50 consisting of two separate parts. The reinforced rubber hose 10 thus obtained had a total thickness of 3.6 mm at the straight tube part 14, an outer diameter of 106 mm at the convex part 11, and an outer diameter of 101 mm at the concave part 12. A height difference between the convex part 11 and the concave part 12 (the depth of the bellows) was about 2.5 mm, and the targeted bellows depth could not be obtained. In addition, the outer surface of the product around the convex part 11 of the bellows was not smooth. That is, when the de-pressurization formation process was not performed, the shape that matches the outer mold 50 could not be obtained. The results are summarized in Table 2.

### Example 4

A reinforced rubber hose 10 having a bellows was obtained in the same manner as for the example 2 except that at time of preparing the airbag 30, the airbag 30 was made to cover the corrugated part 43 of the inner mold 40 and the entire cylindrical part 44 at the both sides. The reinforced rubber hose 10 thus obtained had a total thickness of 3.6 mm at the straight tube part 14, an outer diameter of 106 mm at the convex part 11, and an outer diameter of 101 mm at the concave part 12. A height difference between the convex part 11 and the concave part 12 (the depth of the bellows) was about 2.5 mm, and the targeted bellows depth could not be obtained. Inner diameters at the both ends of three samples prepared by the identical method were within the range of 100.3 to 101.7 mm. In addition, the outer surface of the product around the convex part 11 of the bellows was not smooth. The results are summarized in Table 2.

TABLE 2

| | Example 2 | Example 3 | Example 4 |
|---|---|---|---|
| Shape of Airbag | Bellows | Bellows | Bellows |
| De-pressurization | Yes | No | Yes |
| formation process | | | |
| Area covered by | Corrugated | Corrugated | Entire |
| airbag | part | part | innermold |
| Outer diameter of | 114 | 106 | 114 |
| product at convex | | | |
| part (mm) | | | |
| Outer diameter of | 101 | 101 | 101 |
| product at concave | | | |
| part (mm) | | | |
| Bellows depth (mm) | 6.5 | 2.5 | 6.5 |
| Inner diameter at | 100.7-101.2 | Not measured | 100.3-101.7 |
| product ends (mm) | | | |
| Product outer | Smooth | Not smooth at | Smooth |
| surface | | the convex part | |

As seen from the comparison of the results of the example 2 and the example 3, the depth of the bellows was insufficient when the de-pressurization formation process was not performed. As shown in the example 1, when the thickness of the preform 20 is small and depth of the bellows is shallow, satisfactory products can be obtained even when the de-pressurization formation process was not performed. When the thickness of the preform 20 is great and the depth of the bellows is deep, as is the case with the example 3, performing the de-pressurization formation process is preferred. Adoption of the de-pressurization formation process can be decided depending on the product specifications. As is clear from the comparison of the results for the example 2 and the example 4, the size precision of the inner diameter at the product ends can be improved when the airbag 30, instead of covering the entire body of the inner mold 40, does not partially cover the cylindrical part 44 on each end of the inner mold 40 leaving partially uncovered so that the preform 20 directly contacts the inner mold 40 at the uncovered part.

1. A method for manufacturing a reinforced rubber hose having bellows, by using an inner mold having, on the outer surface thereof, corrugations matching the shape of the bellows, and an outer mold having, on the inner surface thereof, corrugations matching the shape of the bellows, the method comprising following steps of:
placing an airbag that is previously and at least partially formed into a bellows shape, on an outer side of the inner mold, so as to cover at least a corrugated part with the airbag;
placing a cylindrical preform comprising unvulcanized rubber and a reinforcement material on the outer side of the airbag;
placing the outer mold on the outer side of the preform;
supplying a pressurized fluid between the inner mold and the airbag so as to inflate the airbag; and
vulcanizing the preform under heating while being pressed against an inner surface of the outer mold.

2. The method for manufacturing a reinforced rubber hose according to claim 1, wherein a gas between the airbag and the preform is depressurized and evacuated before inflating the airbag so as to press the preform against the airbag.

3. The method for manufacturing a reinforced rubber hose according to claim 1, wherein a clearance between the inner mold and the outer mold across the corrugated part is greater than a total of the thickness of the hose after vulcanization and the thickness of the airbag.

4. The method for manufacturing a reinforced rubber hose according to claim 1, wherein an uncorrugated cylindrical part is provided at least at one end of the inner mold, the cylindrical part is not covered with the airbag at least partially, and the preform directly contacts the inner mold.

5. The method for manufacturing a reinforced rubber hose according to claim 1, wherein the airbag is made of vulcanized rubber formed into a bellows shape.

6. The method for manufacturing a reinforced rubber hose according to claim 1, wherein the preform is formed into a tubular shape by rolling a reinforced rubber sheet made of unvalcanized rubber and a reinforcement material.

7. The method for manufacturing a reinforced rubber hose according to claim 1, wherein the preform is so formed that unvulcanized rubber is kneaded, extruded in a tubular shape, and then combined with a reinforcement material.

8. The method for manufacturing a reinforced rubber hose according to claim 1, wherein the reinforced rubber hose is an intercooler hose, a retarder hose, or a radiator hose.
